(19) United States
(12) Patent Application Publication
(10) Pub. No.: US 2005/0031839 A1
(43) Pub. Date: Feb. 10, 2005

(54) Multilayer structure

(75) Inventors: Haruyasu Mizutani, Nishikasugai-gun (JP); Yasuhiro Yamaguchi, Nishikasugai-gun (JP); Shuhei Yamada, Nishikasugai-gun (JP)

Correspondence Address: POSZ & BETHARDS, PLC, 11250 ROGER BACON DRIVE, SUITE 10, RESTON, VA, 20190, US

(73) Assignee: TOYODA GOSEI CO., LTD.

(21) Appl. No.: 10/889,357

(22) Filed: Jul. 13, 2004

(30) Foreign Application Priority Data
Jul. 15, 2003 (JP) P2003-274915

(51) Int. Cl. B32B 25/04; B32B 25/14

(52) U.S. Cl. 428/212; 428/515

(57) ABSTRACT

A multilayer structure including a laminate of a surface layer of an olefin thermoplastic elastomer (A) and an inner layer of an olefin thermoplastic elastomer (B), wherein: the olefin thermoplastic elastomer (A) contains polyolefin, and soft components (A) made of rubber and process oil (A); the olefin thermoplastic elastomer (B) contains polyolefin, and soft components (B) made of rubber and process oil (B); Mₐ and M_{b} satisfy the relation Mₐ≦M_{b} in which Mₐ is the molecular weight of the process oil (A), and M_{b} is the molecular weight of the process oil (B); and Cₐ and C_{b} satisfy the relation Cₐ<C_{b} in which Cₐ is the amount (wt %) of the soft components (A), and C_{b} is the amount (wt %) of the soft components (B)

The present application is based on Japanese Patent Application No. 2003-274915, the entire contents of which are incorporated herein by reference.

### BACKGROUND OF THE INVENTION

1. Field of the Invention

The present invention relates to a multilayer structure including a laminate of a surface layer of an olefin thermoplastic elastomer and an inner layer of an olefin thermoplastic elastomer.

2. Related Art

A multilayer structure including a laminate of a plurality of resin layers has been heretofore used as an exterior or interior material for a car. When the resin layers in the multilayer structure are made of different resin materials respectively, the function of the multilayer structure can be allocated to the respective resin layers. For this reason, the multilayer structure is preferably used as a car exterior or interior material such as a roof decoration or an opening trim requiring external appearance quality such as mar-proofness, weather resistance, etc., and other various characteristics such as easiness in attachment to a car body or the like.

Vinyl chloride or the like has been heretofore used as a material for this type multilayer structure. This is because excellent characteristic of vinyl chloride can be used for forming a multilayer structure excellent in flexibility and easiness in attachment to another member.

Avoidance of use of vinyl chloride has been however required recently due to a problem of recycling, that is, due to a problem that vinyl chloride generates a harmful substance when recycled.

Therefore, a multilayer structure using an olefin thermoplastic elastomer instead of vinyl chloride has been proposed (see Japanese Patent Laid-Open No. JP 2001-219511A) When an olefin thermoplastic elastomer is used thus, a multilayer structure having flexibility and excellent recyclability can be obtained.

The background-art multilayer structure, however, has a problem that the surface of the multilayer structure glitters under a high temperature condition. It is conceived that this phenomenon occurs because process oil low in mutual solubility with the resin component and rubber migrates and bleeds to the surface of the multilayer structure when the molecular motion of polymer as the resin component is activated under the high temperature condition.

As described above, the multilayer structure having its surface glittering under a high temperature condition is not always adapted for an application such as a car exterior or interior material which is apt to be exposed under a high temperature condition.

To solve the problem, there has been proposed a laminate of two kinds of olefin thermoplastic elastomers in which the amount of an amorphous component and the ratio of an oily softening agent are specified (Japanese Patent Laid-Open No. JP 2001-138440A). When the amount of the amorphous component and the ratio of the oily softening agent are specified thus, a laminate having its surface hardly changing even under a high temperature condition can be obtained.

In the laminate described in JP 2001-138440, it is still impossible to restrain sufficiently the process oil in the laminate from bleeding to the surface of the laminate. As a result, glittering often occurs on the surface of the laminate under a high temperature condition.

### SUMMARY OF THE INVENTION

The invention has been developed in order to solve the problem in the background art. An object of the invention is to provide a multilayer structure in which glittering of its surface can be avoided even under a high temperature and which is excellent in mar-proofness and easiness in attachment.

The invention provides a multilayer structure including a laminate of a surface layer of an olefin thermoplastic elastomer (A) and an inner layer of an olefin thermoplastic elastomer (B), wherein: the olefin thermoplastic elastomer (A) contains polyolefin, and soft components (A) made of rubber and process oil (A); the olefin thermoplastic elastomer (B) contains polyolefin, and soft components (B) made of rubber and process oil (B); Mₐ and M_{b} satisfy the relation Mₐ≦M_{b} in which Mₐ is the molecular weight of the process oil (A) contained in the olefin thermoplastic elastomer (A), and M_{b} is the molecular weight of the process oil (B) contained in the olefin thermoplastic elastomer (B); and Cₐ and C_{b} satisfy the relation Cₐ<C_{b} in which Cₐ is the amount (wt %) of the soft components (A) contained in the olefin thermoplastic elastomer (A), and C_{b} is the amount (wt %) of the soft components (B) contained in the olefin thermoplastic elastomer (B).

The operation and effect of the invention will be described below.

The multilayer structure according to the invention includes a laminate of the surface layer of the olefin thermoplastic elastomer (A) and the inner layer of the olefin thermoplastic elastomer (B). The molecular weight Mₐ of the process oil (A) contained in the olefin thermoplastic elastomer (A) and the molecular weight M_{b} of the process oil (B) contained in the olefin thermoplastic elastomer (B) have the relation Mₐ≦M_{b}. The amount Cₐ of the soft components (A) contained in the olefin thermoplastic elastomer (A) is smaller than the amount C_{b} of the soft components (B) contained in the olefin thermoplastic elastomer (B).

For this reason, the multilayer structure according to the invention has its surface hardly glittering even under a high temperature.

This reason is supposed as follows.

As described above, it is conceived that the surface of the multilayer structure glitters when process oil low in mutual solubility with the resin component and rubber contained in the olefin thermoplastic elastomer migrates to the surface of the surface layer.

In the multilayer structure according to the invention, as described above, the molecular weight of process oil (A) contained in the surface layer is selected to be equal to or lower than that of process oil (B) contained in the inner layer. Migration of process oil under a high temperature hardly occurs when the molecular weight of process oil (A) contained in the surface layer is selected to be equal to that of process oil (B) contained in the inner layer. On the other hand, when the molecular weight of process oil (A) contained in the surface layer is selected to be larger than that of process oil (B) contained in the inner layer, process oil migrates from the surface layer to the inner layer under a high temperature.

It is therefore conceived that glittering of the surface of the multilayer structure according to the invention can be avoided because bleeding of process oil to the surface of the surface layer can be prevented.

The surface layer of the multilayer structure according to the invention is high in surface hardness, so that the multilayer structure can exhibit excellent mar-proofness. Because the inner layer contains the soft components, the inner layer has flexibility and excellent easiness in attachment of the multilayer structure to another member.

As described above, in accordance with the invention, there can be provided a multilayer structure in which glittering of its surface can be avoided even under a high temperature and which is excellent in mar-proofness and easiness in attachment.

A multilayer structure according to the invention includes a surface layer and an inner layer each of which contains polyolefin, rubber and process oil. The inner layer may be a single layer or a laminated layer having a plurality of layers.

The multilayer structure can be produced as follows. An olefin thermoplastic elastomer (A) containing polyolefin, rubber and process oil (A) and an olefin thermoplastic elastomer (B) containing polyolefin, rubber and process oil (B) are prepared. For example, these olefin thermoplastic elastomers (A) and (B) are laminated and thermally fusion-bonded to each other while extrusion-molded by use of two extruders. Alternatively, for example, two kinds of resin materials may be extrusion-molded separately. In this case, after cooled, these resin materials are bonded to each other by an adhesive agent or the like.

Examples of olefin as a raw material of polyolefin in each of the surface layer and the inner layer include ethylene, propylene, 1-butene, 1-pentene, 1-hexene, 1-octene, 1-decene, 2-methyl-1-propene, 3-methyl-1-pentene, 4-methyl-1-pentene, and 5-methyl-1-hexene.

A single olefin material may be used as the olefin. Alternatively, a combination of two or more kinds of olefin materials or a copolymer containing two or more kinds of olefin materials may be used as the olefin.

Especially, polypropylene is preferably used as the polyolefin.

In this case, the strength of the multilayer structure can be improved.

For example, ethylene-α-olefin elastomer or/and styrene elastomer can be used as the rubber.

Examples of the ethylene-α-olefin elastomer include EPR (ethylene-propylene rubber), EPDM (ethylene-propylene-diene terpolymer rubber), EBR (ethylene-butene rubber), and EOR (ethylene-octene rubber). A single material may be used as the elastomer or a combination of two or more kinds of materials may be used as the elastomer. EPDM is preferably used as the elastomer.

Examples of the styrene elastomer include SBR (styrene-butadiene rubber), SBS (styrene-butadiene-styrene block copolymer), SIS (styrene-isoprene-styrene block copolymer), SEBS (styrene-ethylene butene-styrene block copolymer), and SEPS (styrene-ethylenepropylene-styrene block copolymer). A single material may be used as the elastomer or a combination of two or more kinds of materials may be used as the elastomer.

SEBS and SEPS may be preferably used as the elastomer.

For example, at least one member selected from paraffin process oil, naphthene process oil and aromatic process oil may be used as each of the process oil (A) and the process oil (B). One material may be used as the process oil (A) and the process oil (B) or different materials maybe used as the process oil (A) and the process oil (B) respectively.

In the invention, the relation Mₐ≦M_{b} is satisfied when Mₐ is the molecular weight of the process oil (A), and M_{b} is the molecular weight of the process oil (B).

If Mₐ is higher than M_{b}, there is a possibility that the surface of the multilayer structure will glitter because the process oil bleeds to the outer surface of the surface layer under a high temperature.

Incidentally, in the case where a plurality of process oil materials are used as each of the process oil (A) and the process oil (B), the relation Mₐ≦M_{b} is satisfied when Mₐ is the average molecular weight of the process oil (A), and M_{b} is the average molecular weight of the process oil (B).

If necessary, other oily softening agents such as ester plasticizer, paraffin oil and liquid paraffin may be used in combination.

In the invention, Cₐ and C_{b} satisfy the relation Cₐ<C_{b} in which Cₐ is the amount (wt %) of the soft components (A) contained in the olefin thermoplastic elastomer (A), and C_{b} is the amount (wt %) of the soft components (B) contained in the olefin thermoplastic elastomer (B).

If Cₐ is not smaller than C_{b}, there is a possibility that the process oil cannot be sufficiently restrained from bleeding to the surface of the multilayer structure. In this case, there is also a possibility that mar-proofness or easiness in attachment to another member will deteriorate.

Preferably, the amount of the soft components (A) contained in the olefin thermoplastic elastomer (A) is smaller than 40 wt % whereas the amount of the soft components (B) contained in the olefin thermoplastic elastomer (B) is not smaller than 40 wt %.

In this case, the process oil can be more sufficiently restrained from bleeding to the surface of the multilayer structure. For this reason, glittering of the multilayer structure under a high temperature can be prevented more sufficiently.

Preferably, the weight ratio of the process oil (A) to rubber in the olefin thermoplastic elastomer (A) is in a range of from 0.5 to 1.5, and the weight ratio of the process oil (B) to rubber in the olefin thermoplastic elastomer (B) is in a range of from 0.5 to 1.5.

If the weight ratio of the process oil (A) or (B) to rubber is lower than 0.5, there is a possibility that production cost will increase because a large amount of rubber is required for giving flexibility to the olefin thermoplastic elastomer (A) or (B) to improve easiness in attachment to a car body or the like. If the weight ratio of the process oil (A) or (B) to rubber is contrariwise higher than 1.5, there is a possibility that the process oil will easily bleed to the surface of the multilayer structure under a high temperature.

Preferably, the molecular weight of the process oil (A) contained in the olefin thermoplastic elastomer (A) is in a range of from400 to 750, and the molecular weight of the process oil (B) contained in the olefin thermoplastic elastomer (B) is in a range of from 400 to 750.

If the molecular weight of the process oil is lower than 400, there is a possibility that bleeding will occur easily because mutual solubility with the thermoplastic elastomer is lowered remarkably. On the other hand, if the molecular weight of the process oil is higher than 750, there is a possibility that a large amount of process oil will be required to increase production cost because softening efficiency is lowered.

Preferably, each of the olefin thermoplastic elastomers (A) and (B) is made of a non-crosslinked material or a dynamic crosslinked material.

In this case, bleeding can be prevented more sufficiently because retentivity of process oil can be further improved.

Preferably, each of the olefin thermoplastic elastomers (A) and (B) contains inorganic filler.

In this case, the production cost of the multilayer structure can be reduced as well as the strength, etc. of the multilayer structure can be improved.

Examples of the inorganic filler that can be used include talc, calcium carbonate, mica, barium sulfate, clay, calcium silicate, and glass fiber.

Preferably, the surface hardness of the surface layer is not lower than 40D.

In this case, the excellent surface hardness of the surface layer can be used so that the multilayer structure is particularly excellent in mar-proofness. For this reason, in this case, the multilayer structure can be preferably used as a car exterior or interior material such as a roof decoration or an opening trim.

### BRIEF DESCRIPTION OF THE DRAWINGS

FIG. 1 is a sectional explanatory view of a multilayer structure according to Embodiment 1 of the invention.

### DETAILED DESCRIPTION OF THE PREFERRED EMBODIMENT

(Embodiment 1)

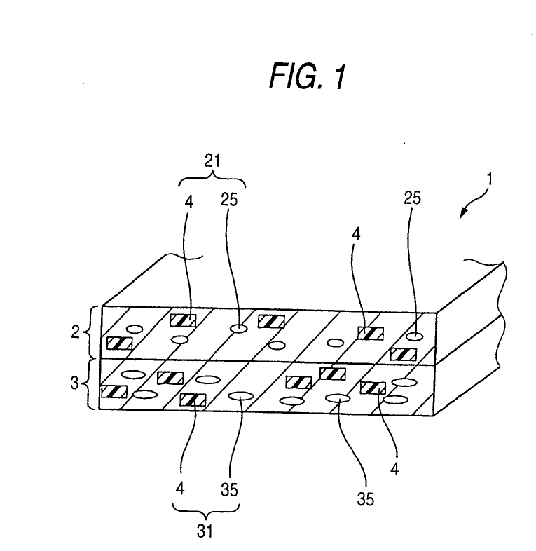

An embodiment of the multilayer structure according to the invention will be described below with reference to FIG. 1.

As shown in FIG. 1, the multilayer structure 1 according to this embodiment includes a laminate of a surface layer 2 of an olefin thermoplastic elastomer (A) and an inner layer 3 of an olefin thermoplastic elastomer (B).

The olefin thermoplastic elastomer (A) contains polyolefin, and soft components (A) 21 which contain rubber 4 and process oil (A) 25. The olefin thermoplastic elastomer (B) contains polyolefin, and soft components (B) 31 which contain rubber 4 and process oil (B) 35.

Mₐ and M_{b} satisfy the relation Mₐ≦M_{b} in which Mₐ is the molecular weight of the process oil (A) 25 contained in the olefin thermoplastic elastomer (A), and M_{b} is the molecular weight of the process oil (B) 35 contained in the olefin thermoplastic elastomer (B).

Cₐ and C_{b} satisfy the relation Cₐ<C_{b} in which Cₐ is the amount (wt %) of the soft components (A) 21 contained in the olefin thermoplastic elastomer (A), and C_{b} is the amount (wt %) of the soft components (B) 31 contained in the olefin thermoplastic elastomer (B).

A method for producing the multilayer structure according to this embodiment will be described below.

First, fifteen kinds of olefin thermoplastic elastomers (sample A to sample O) different in the mixture ratio of polyolefin, rubber and process oil are prepared as shown in the following Tables 1 and 2.

Each of these samples A to O contains polypropylene (J105 made by Sumitomo Mitsui Polyolefin; block copolymer, MFR=13 g/10 min) as the polyolefin, EPDM (EPT3091 made by Mitsui Chemicals; Mooney viscosity 83 ML₁₊₄ (100° C.)) as the rubber, and paraffin process oil as the process oil.

Three kinds (Mw=400, 540and750) of process oil different in molecular weight Mw are prepared as the paraffin process oil. Each of the samples A to O contains any one of these kinds of process oil as shown in the following Tables 1 and 2. Specifically, Diana process oil PW-32 (Mw=400), Diana process oil PW-90 (Mw=540) or Diana process oil PW-380 (Mw=750) made by Idemitsu Kosan Co., Ltd. is used.

Then, the aforementioned propylene, process oil, rubber and talc (LMS#100 made by Fuji Talc Industry Co.) are mixed so that fifteen kinds of olefin thermoplastic elastomers (sample A to sample O) are produced. The mixture composition of each sample, the molecular weight of process oil, the mixture ratio of process oil to rubber and the surface hardness of the multilayer structure after molding are shown in Tables 1 and 2.

The surface hardness of each of the samples A to O is measured as follows.

That is, both Shore D and Shore A are measured about one 6 mm-thick press sheet according to JIS K7215. Values after 15 seconds are read as both values.

In each of the samples A to F, Shore D is measured. In each of the samples G to O, Shore A is measured and converted into Shore D. Results of the measurement are shown in Tables 1 and 2. In Tables 1 and 2, the surface hardness of each sample is expressed so that D is added to the measured value of Shore D or the converted value of Shore D from Shore A whereas A is added to the measured value of Shore A.

TABLE 1

| | | | Kind of Thermoplastic Elastomer | | | | | | | |
|---|---|---|---|---|---|---|---|---|---|---|
| | | | Sample A | Sample B | Sample C | Sample D | Sample E | Sample F | Sample G | Sample H |
| Composition | Polypropylene | | 70 | 70 | 70 | 70 | 70 | 50 | 30 | 30 |
| | Soft | Process | 10 | 15 | 15 | 15 | 17 | 25 | 30 | 30 |
| | Components | oil | | | | | | | | |
| | | Rubber | 20 | 15 | 15 | 15 | 13 | 25 | 40 | 40 |

| | | | | | | | | | |
|---|---|---|---|---|---|---|---|---|---|
| | Talc | 0 | 0 | 0 | 0 | 0 | 0 | 0 | 0 |
| Material | Process oil/Rubber | 0.5 | 1 | 1 | 1 | 1.3 | 1 | 0.75 | 0.75 |
| Characteristic | | | | | | | | | |
| | Component Ratio | | | | | | | | |
| | Molecular Weight of | 750 | 400 | 540 | 750 | 750 | 750 | 400 | 540 |
| | Process Oil | | | | | | | | |
| | Surface | 47D | 48D | 48D | 48D | 49D | 38D | 18D | 18D |
| | Hardness* | | | | | | | (63A) | (62A) |

*Samples A to F: Shore D was measured.
Samples G and H: Shore A was measured and converted into Shore D (the measured value of Shore A was put in parentheses).

TABLE 2

| | | | Kind of Thermoplastic Elastomer | | | | | | |
|---|---|---|---|---|---|---|---|---|---|
| | | | Sample I | Sample J | Sample K | Sample L | Sample M | Sample N | Sample O |
| Composition | Polypropylene | | 30 | 30 | 30 | 30 | 30 | 20 | 30 |
| | Soft | Process | 30 | 35 | 40 | 40 | 40 | 40 | 20 |
| | Components | oil | | | | | | | |
| | | Rubber | 40 | 35 | 30 | 30 | 30 | 40 | 20 |

| | | | | | | | | |
|---|---|---|---|---|---|---|---|---|
| | Talc | 0 | 0 | 0 | 0 | 0 | 0 | 30 |
| Material | Process oil/Rubber | 0.75 | 1 | 1.3 | 1.3 | 1.3 | 1 | 1 |
| Characteristic | Component Ratio | | | | | | | |
| | Molecular Weight of | 750 | 750 | 400 | 540 | 750 | 750 | 750 |
| | Process Oil | | | | | | | |
| | Surface Hardness | 18D | 19D | 20D | 20D | 20D | 19D | 40D |
| | | (63A) | (68D) | (70A) | (70A) | (70A) | (68A) | (90A) |

*Samples I to O: Shore A was measured and converted into Shore D (the measured value of Shore A was put in parentheses).

Then, two kinds of olefin thermoplastic elastomers are selected from the samples A to O prepared as described above. The two kinds of olefin thermoplastic elastomers are molded and laminated so that a multilayer structure 1 as shown in FIG. 1 is produced. Specifically, selected one of the samples A to F is used as the olefin thermoplastic elastomer (A) for the surface layer while selected one of the samples A, D and E to O is used as the olefin thermoplastic elastomer (B) for the inner layer. In this manner, 78 kinds of multilayer structures in total are produced. Combinations of the olefin thermoplastic elastomers (A) and (B) are shown in Table 3 which will be described later.

In the production of the multilayer structure, first, the olefin thermoplastic elastomers (A) and (B) are molded into sheets by two 20 mm extruders (L/D=22). On this occasion, the two sheets are piled up and fusion-bonded to each other while they are sufficiently heated by molding. Then, the resulting sheet is cooled and cut into a size of 3 cm by 3 cm by 2 mm so that a multilayer structure 1 as shown in FIG. 1 is produced.

Incidentally, the molding condition at the time of molding is as follows.

Molding Temperature: (C1-C2-C3-D1)=(80-190-190-190° C.) in the condition that a breaker plate is used.

Rotational Speed: 20 rpm

Dice Shape: 30 mm wide by 2 mm thick

In the condition, C1, C2 and C3 are temperatures of cylinders respectively. The temperature of a cylinder nearest to the hopper side is expressed as C1. The temperatures of cylinders are expressed as C2 and C3 in increasing order of distance from the hopper side. D1 is the temperature of the dice.

<Heat Resistance Test>

Then, the 78 kinds of multilayer structures produced in the aforementioned manner are subjected to a heat resistance test.

Specifically, each multilayer structure produced in the aforementioned manner is first heated in an oven at a temperature of 90° C. for 100 hours. Then, the multilayer structure is cooled. The surface of the surface layer of the multilayer structure is examined by eye observation.

The case where glittering is observed remarkably on the whole of the surface of the surface layer of the multilayer structure is evaluated as “III”. The case where glittering is slightly observed on part of the surface is evaluated as “II”. The case where glittering is not observed at all is evaluated as “I”.

Results of the eye observation are shown in Table 3.

TABLE 3

| | | Surface Layer/Thermoplastic Elastomer (A) | | | | | |
|---|---|---|---|---|---|---|---|
| | | Sam- | Sam- | Sam- | Sam- | Sam- | Sam- |
| | | ple A | ple B | ple C | ple D | ple E | ple F |
| Inner Layer/ | Sample A | II | II | II | II | II | II |
| Thermoplastic | Sample D | II | II | II | II | II | II |
| Elastomer | Sample E | II | II | II | II | II | II |
| (B) | Sample F | I | I | I | I | I | II |
| | Sample G | III | I | III | III | III | III |
| | Sample H | III | I | I | III | III | III |
| | Sample I | I | I | I | I | I | I |
| | Sample J | I | I | I | I | I | I |
| | Sample K | III | I | III | III | III | III |
| | Sample L | III | I | I | III | III | III |
| | Sample M | I | I | I | I | I | I |
| | Sample N | I | I | I | I | I | I |
| | Sample O | I | I | I | I | I | II |

As is obvious from Tables 1 to 3, it is found that glittering of the multilayer structure can be suppressed when the olefin thermoplastic elastomer (A) for the surface layer and the olefin thermoplastic elastomer (B) for the inner layer are combined so that the relation Mₐ≦M_{b} is satisfied when Mₐ is the molecular weight of the process oil (process oil (A)) contained in the olefin thermoplastic elastomer (A) and M_{b} is the molecular weight of the process oil (process oil (B)) contained in the olefin thermoplastic elastomer (B).

It is also found that glittering of the multilayer structure can be further suppressed when the olefin thermoplastic elastomer (A) for the surface layer and the olefin thermoplastic elastomer (B) for the inner layer are combined so that the relation Cₐ<C_{b} is satisfied when Cₐ is the amount (wt %) of the soft components (soft components (A)) contained in the olefin thermoplastic elastomer (A) and C_{b} is the amount (wt %) of the soft components (soft components (B)) contained in the olefin thermoplastic elastomer (B).

(Embodiment 2)

Next, in this embodiment, olefin thermoplastic elastomers prepared in Embodiment 1 are used for producing multilayer structures in the same manner as in Embodiment 1. The mar-proofness and easiness in product attachment (body following property) of each multilayer structure are examined.

Specifically, selected one of samples A, D, F and J prepared in Embodiment 1 is used as the olefin thermoplastic elastomer (A) for the surface layer while selected one of samples D, J and O is used as the olefin thermoplastic elastomer (B) for the inner layer. Consequently, 12 kinds of multilayer structures are produced in the same manner as in Embodiment 1. Combinations of the olefin thermoplastic elastomers (A) and (B) are shown in Table 4 which will be described later.

Then, the mar-proofness and easiness in product attachment of each multilayer structure produced as described above are examined as follows.

(Mar-proofness)

The following scratch test and abrasive wear test are carried out. The case where change in gloss value is not larger than 10% compared with the gloss value before the test is evaluated as “I”. The case where change in gloss value is in a range of from 11 to 24% is evaluated as “II”. The case where change in gloss value is not smaller than 25% is evaluated as “III”.

Results of the tests are shown in Table 4.

[Scratch Test]

A point of a pencil is applied to the surface of the multilayer structure at room temperature and slid at a contact angle of45° under a load of 4.9N. Then, the external appearance of the multilayer structure is examined by eye observation, so that the external appearance of the test piece is compared with that of the test piece before the test.

[Abrasive Wear Test]

Cotton duck is set on a contact portion at room temperature. The test portion is slid on the sample (20 mm by 100 mm) by 30 round trips while a load of 1 kgf is applied on the sample perpendicularly. Then, the external appearance of the sample is examined by eye observation, so that the external appearance of the sample is compared with that of the sample before the test.

(Easiness in Product Attachment)

A 100 mm-cut test piece is set in an exclusive jig corresponding to the aperture of the body. The maximum insertion force (F1) is measured when the test piece is inserted in the exclusive jig at a speed of 20±5 mm/min.

The case where the maximum insertion force is not higher than 35 N is evaluated as “I”. The case where the maximum insertion force is higher than 35 N is evaluated as “III”.

Results of the test are shown in Table 4.

TABLE 4

| | | Surface Layer (Thermoplastic Elastomer A) | | | | | |
|---|---|---|---|---|---|---|---|
| | | Sample A | Sample D | Sample F | Sample J | Sample D | Sample D |
| | | Inner Layer (Thermoplastic Elastomer B) | | | | | |
| | | Sample J | Sample J | Sample J | Sample J | Sample D | Sample O |
| Product | Mar-proofness | I | I | II | III | I | I |
| Characteristic | Easiness in | I | I | I | I | III | I |
| | Product | | | | | | |
| | Attachment | | | | | | |
| | (Body | | | | | | |
| | Following | | | | | | |
| | Property | | | | | | |

As is obvious from Table 4, a multilayer structure excellent in mar-proofness and easiness in product attachment can be obtained when a combination of samples A and J, a combination of samples D and J, a combination of samples F and J or a combination of samples D and O is used as the combination of the olefin thermoplastic elastomers (A) and (B) for the surface layer and the inner layer, that is, when the two relations Mₐ≦M_{b} and Cₐ<C_{b} are satisfied. On the other hand, mar-proofness or easiness in product attachment is insufficient when a combination of samples J or a combination of samples D is used, that is, when the relation Cₐ<C_{b} is not satisfied.

As described above, it is obvious that the multilayer structure according to the invention is excellent in mar-proofness and easiness in attachment as well as glittering of the surface of the multilayer structure can be avoided even under a high temperature.

1. A multilayer structure comprising a laminate of a surface layer of an olefin thermoplastic elastomer (A) and an inner layer of an olefin thermoplastic elastomer (B), wherein:
said olefin thermoplastic elastomer (A) contains polyolefin, and soft components (A) made of rubber and process oil (A);
said olefin thermoplastic elastomer (B) contains polyolefin, and soft components (B) made of rubber and process oil (B);
Mₐ and M_{b} satisfy the relation Mₐ≦M_{b} in which Mₐ is the molecular weight of said process oil (A) contained in said olefin thermoplastic elastomer (A), and M_{b} is the molecular weight of said process oil (B) contained in said olefin thermoplastic elastomer (B); and
Cₐ and C_{b} satisfy the relation Cₐ<C_{b} in which Cₐ is the amount (wt %) of said soft components (A) contained in said olefin thermoplastic elastomer (A), and C_{b} is the amount (wt %) of said soft components (B) contained in said olefin thermoplastic elastomer (B).

2. A multilayer structure according to claim 1, wherein:
the amount of said soft components (A) contained in said olefin thermoplastic elastomer (A) is smaller than 40 wt %; and
the amount of said soft components (B) contained in said olefin thermoplastic elastomer (B) is not smaller than 40 wt %.

3. A multilayer structure according to claim 1, wherein:
the weight ratio of said process oil (A) to said rubber in said olefin thermoplastic elastomer (A) is in a range of from 0.5 to 1.5; and
the weight ratio of said process oil (B) to said rubber in said olefin thermoplastic elastomer (B) is in a range of from 0.5 to 1.5.

4. A multilayer structure according to claim 1, wherein:
the molecular weight of said process oil (A) contained in said olefin thermoplastic elastomer (A) is in a range of from 400 to 750; and
the molecular weight of said process oil (B) contained in said olefin thermoplastic elastomer (B) is in a range of from 400 to 750.

5. A multilayer structure according to claim 1, wherein each of said olefin thermoplastic elastomers (A) and (B) is made of either non-crosslinked material or dynamic crosslinked material.

6. A multilayer structure according to claim 1, wherein said rubber is ethylene/α-olefin elastomer or/and styrene elastomer.

7. A multilayer structure according to claim 1, wherein each of said olefin thermoplastic elastomers (A) and (B) contains inorganic filler.

8. A multilayer structure according to claim 1, wherein said surface layer has a surface hardness of not smaller than 40D.
